(19) United States
(12) Patent Application Publication
(10) Pub. No.: US 2008/0063369 A1
(43) Pub. Date: Mar. 13, 2008

(54) Method and apparatus for reproducing data, recording medium, and method and apparatus for recording data

(76) Inventors: Kun Suk KIM, Anyang-si (KR); Jea Yong YOO, Seongnam-si (KR)

Correspondence Address: HARNESS, DICKEY & PIERCE, P.L.C., P.O. BOX 8910, RESTON, VA, 20195, US

(21) Appl. No.: 11/978,646

(22) Filed: Oct. 30, 2007

Related U.S. Application Data
(63) Continuation of application No. 11/506,897, filed on Aug. 21, 2006.

(30) Foreign Application Priority Data
Apr. 17, 2006 (KR) 10-2006-0034477

(51) Int. Cl. H04N 7/00

(52) U.S. Cl. 386/95

(57) ABSTRACT

In one embodiment, the method includes reproducing management information for managing reproduction of at least one secondary video stream and at least one secondary audio stream. The secondary video stream represents the picture-in-picture presentation path with respect to a primary presentation path represented by a primary video stream. The management information includes first combination information, and the first combination information indicates the secondary audio streams that are combinable with the secondary video stream. At least one of the secondary audio streams may be reproduced based on the first combination information.

### DOMESTIC PRIORITY INFORMATION

This application claims the benefit of the U.S. Provisional Application Nos. 60/709,807 and 60/737,412 filed Aug. 22, 2005 and Nov. 17, 2005, respectively, which are all hereby incorporated by reference in their entirety.

This application is a continuation of U.S. patent application Ser. No. 11/506,897 filed on Aug. 21, 2006, the entirety of which is hereby incorporated by reference.

### FOREIGN PRIORITY INFORMATION

This application claims the benefit of the Korean Patent Application No. 10-2006-0034477, filed on Apr. 17, 2006, which is hereby incorporated by reference in its entirety.

### BACKGROUND OF THE INVENTION

1. Field of the Invention

The present invention relates to recording and reproducing methods and apparatuses, and a recording medium.

2. Discussion of the Related Art

Optical discs are widely used as a recording medium capable of recording a large amount of data therein. Particularly, high-density optical recording mediums such as a Blu-ray Disc (BD) and a high definition digital versatile disc (HD-DVD) have recently been developed, and are capable of recording and storing large amounts of high-quality video data and high-quality audio data.

Such a high-density optical recording medium, which is based on next-generation recording medium techniques, is considered to be a next-generation optical recording solution capable of storing much more data than conventional DVDs. Development of high-density optical recording mediums is being conducted, together with other digital appliances. Also, an optical recording/reproducing apparatus, to which the standard for high density recording mediums is applied, is under development.

In accordance with the development of high-density recording mediums and optical recording/reproducing apparatuses, it is possible to simultaneously reproduce a plurality of videos. However, there is known no method capable of effectively simultaneously recording or reproducing a plurality of videos. Furthermore, it is difficult to develop a complete optical recording/reproducing apparatus based on high-density recording mediums because there is no completely-established standard for high-density recording mediums.

### SUMMARY OF THE INVENTION

The present invention relates to a method of managing reproduction of audio for at least one picture-in-picture presentation path.

In one embodiment, the method includes reproducing management information for managing reproduction of at least one secondary video stream and at least one secondary audio stream. The secondary video stream represents the picture-in-picture presentation path with respect to a primary presentation path represented by a primary video stream. The management information includes first combination information, and the first combination information indicates the secondary audio streams that are combinable with the secondary video stream. At least one of the secondary audio streams may be reproduced based on the first combination information.

In one embodiment, the first combination information includes an information field indicating a number of secondary audio stream entries associated with the secondary video stream, and the combination information provides a secondary audio stream identifier for each of the number of the secondary audio stream entries.

In another embodiment, the management information indicates a number of secondary video stream entries, and for each of the number of secondary video stream entries, the management information provides a secondary video stream identifier and the first combination information.

In a further embodiment, the management information includes second combination information, and the second combination information indicates the primary audio streams that are combinable with the secondary audio stream.

In one embodiment, the second combination information includes an information field indicating a number of primary audio stream entries associated with the secondary audio stream, and the second combination information provides a primary audio stream identifier for each of the number of the primary audio stream entries.

The present invention further relates to an apparatus for managing reproduction of audio for at least one picture-in-picture presentation path.

In one embodiment, the apparatus includes a driver configured to drive a reproducing device to reproduce data from the recording medium. A controller is configured to control the driver to reproduce management information for managing reproduction of at least one secondary video stream and at least one secondary audio stream. The secondary video stream represents the picture-in-picture presentation path with respect to a primary presentation path represented by a primary video stream. The management information includes first combination information, and the first combination information indicates the secondary audio streams that are combinable with the secondary video stream. The controller is also configured to reproduce at least one of the secondary audio streams based on the first combination information.

One embodiment further includes a secondary audio decoder configured to decode one of the secondary audio streams indicated as combinable with the secondary video stream.

Another embodiment further includes a secondary audio decoder and a primary audio decoder. The secondary audio decoder is configured to decode one of the secondary audio streams indicated as combinable with the secondary video stream. The primary audio decoder is configured to decode at least one of the primary audio streams indicated as combinable with the decoded secondary audio stream.

The present invention further relates to a recording medium having a data structure for managing reproduction of audio for at least one picture-in-picture presentation path.

In one embodiment, the recording medium includes a data area storing a primary video stream, a secondary video stream, at least one primary audio stream, and at least one secondary audio stream. The primary video stream represents a primary presentation path, and the secondary video stream represents a picture-in-picture presentation path with respect to the primary presentation path. The primary audio stream is associated with the primary video stream, and the secondary audio stream is associated with the secondary video stream. The recording medium also includes a management area storing management information for managing reproduction of the secondary video stream and at least one of the secondary audio streams. The management information includes first combination information, and the first combination information indicates the secondary audio streams that are combinable with the secondary video stream.

The present invention still further relates to a method and an apparatus for recording a data structure for managing reproduction of audio for at least one picture-in-picture presentation path.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a schematic view illustrating an exemplary embodiment of the combined use of an optical recording/reproducing apparatus according to an embodiment of the present invention and a peripheral appliance;

FIG. 2 is a schematic diagram illustrating a structure of files recorded in an optical disc as a recording medium according to an embodiment of the present invention;

FIG. 3 is a schematic diagram illustrating a data recording structure of the optical disc as the recording medium according to an embodiment of the present invention;

FIG. 4 is a schematic diagram for understanding a concept of a secondary video according to an embodiment of the present invention;

FIG. 5 is a schematic diagram illustrating an exemplary embodiment of a table including stream entries of the secondary video;

FIG. 6 is a schematic diagram illustrating an exemplary embodiment of the secondary video metadata according to the present invention;

FIG. 7 is a block diagram illustrating the overall configuration of an optical recording/reproducing apparatus according to an embodiment of the present invention;

FIG. 8 is a block diagram illustrating an AV decoder model according to an embodiment of the present invention;

FIG. 9 is a block diagram illustrating the overall configuration of an audio mixing model according to an embodiment of the present invention;

FIGS. 10A and 10B are schematic diagrams illustrating embodiments of a data encoding method according to the present invention,

FIG. 11 is a schematic diagram explaining a playback system according to an embodiment of the present invention;

FIG. 12 is a schematic diagram illustrating an exemplary embodiment of status memory units equipped in the optical recording/reproducing apparatus according to the present invention;

FIGS. 13A to 13C are schematic diagrams illustrating sub path types according to embodiments of the present invention, respectively; and

FIG. 14 is a flow diagram illustrating a method for reproducing data in accordance with an embodiment of the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts.

In the following description, example embodiments of the present invention will be described in conjunction with an optical disc as an example recording medium. In particular, a Blu-ray disc (BD) is used as an example recording medium, for the convenience of description. However, it will be appreciated that the technical idea of the present invention is applicable to other recording mediums, for example, HD-DVD, equivalently to the BD.

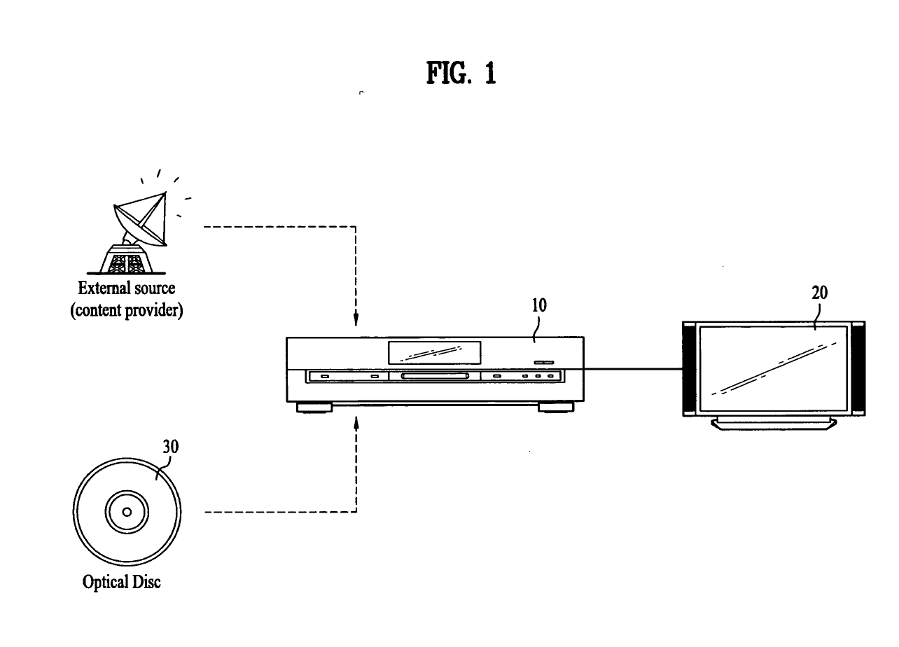

“Storage” as generally used in the embodiments is a storage equipped in a optical recording/reproducing apparatus (FIG. 1). The storage is an element in which the user freely stores required information and data, to subsequently use the information and data. For storages, which are generally used, there are a hard disk, a system memory, a flash memory, and the like. However, the present invention is not limited to such storages.

In association with the present invention, the “storage” is also usable as means for storing data associated with a recording medium (for example, a BD). Generally, the data stored in the storage in association with the recording medium is externally-downloaded data.

As for such data, it will be appreciated that partially-allowed data directly read out from the recording medium, or system data produced in association with recording and production of the recording medium (for example, metadata) can be stored in the storage.

For the convenience of description, in the following description, the data recorded in the recording medium will be referred to as “original data”, whereas the data stored in the storage in association with the recording medium will be referred to as “additional data”.

Also, “title” defined in the present invention means a reproduction unit interfaced with the user. Titles are linked with particular objects, respectively. Accordingly, streams recorded in a disc in association with a title are reproduced in accordance with a command or program in an object linked with the title. In particular, for the convenience of description, in the following description, among the titles including video data according to an MPEG compression scheme, titles supporting features such as seamless multi-angle and multi story, language credits, director's cuts, trilogy collections, etc. will be referred to as “High Definition Movie (HDMV) titles”. Also, among the titles including video data according to an MPEG compression scheme, titles providing a fully programmable application environment with network connectivity thereby enabling the content provider to create high interactivity will be referred to as “BD-J titles”.

FIG. 1 illustrates an exemplary embodiment of the combined use of an optical recording/reproducing apparatus according to the present invention and a peripheral appliance.

The optical recording/reproducing apparatus 10 according to an embodiment of the present invention can record or reproduce data in/from various optical discs having different formats. If necessary, the optical recording/reproducing apparatus 10 may be designed to have recording and reproducing functions only for optical discs of a particular format (for example, BD), or to have a reproducing function alone, except for a recording function. In the following description, however, the optical recording/reproducing apparatus 10 will be described in conjunction with, for example, a BD-player for playback of a BD, or a BD-recorder for recording and playback of a BD, taking into consideration the compatibility of BDs with peripheral appliances, which must be solved in the present invention. It will be appreciated that the optical recording/reproducing apparatus 10 of the present invention may be a drive which can be built in a computer or the like.

The optical recording/reproducing apparatus 10 of the present invention not only has a function for recording and playback of an optical disc 30, but also has a function for receiving an external input signal, processing the received signal, and sending the processed signal to the user in the form of a visible image through an external display 20. Although there is no particular limitation on external input signals, representative external input signals may be digital multimedia broadcasting-based signals, Internet-based signals, etc. Specifically, as to Internet-based signals, desired data on the Internet can be used after being downloaded through the optical recording/reproducing apparatus 10 because the Internet is a medium easily accessible by any person.

In the following description, persons who provide contents as external sources will be collectively referred to as a “content provider (CP)”.

“Content” as used in the present invention may be the content of a title, and in this case means data provided by the author of the associated recording medium.

Hereinafter, original data and additional data will be described in detail. For example, a multiplexed AV stream of a certain title may be recorded in an optical disc as original data of the optical disc. In this case, an audio stream (for example, Korean audio stream) different from the audio stream of the original data (for example, English) may be provided as additional data via the Internet. Some users may desire to download the audio stream (for example, Korean audio stream) corresponding to the additional data from the Internet, to reproduce the downloaded audio stream along with the AV stream corresponding to the original data, or to reproduce the additional data alone. To this end, it is desirable to provide a systematic method capable of determining the relation between the original data and the additional data, and performing management/reproduction of the original data and additional data, based on the results of the determination, at the request of the user.

As described above, for the convenience of description, signals recorded in a disc have been referred to as “original data”, and signals present outside the disc have been referred to as “additional data”. However, the definition of the original data and additional data is only to classify data usable in the present invention in accordance with data acquisition methods. Accordingly, the original data and additional data should not be limited to particular data. Data of any attribute may be used as additional data as long as the data is present outside an optical disc recorded with original data, and has a relation with the original data.

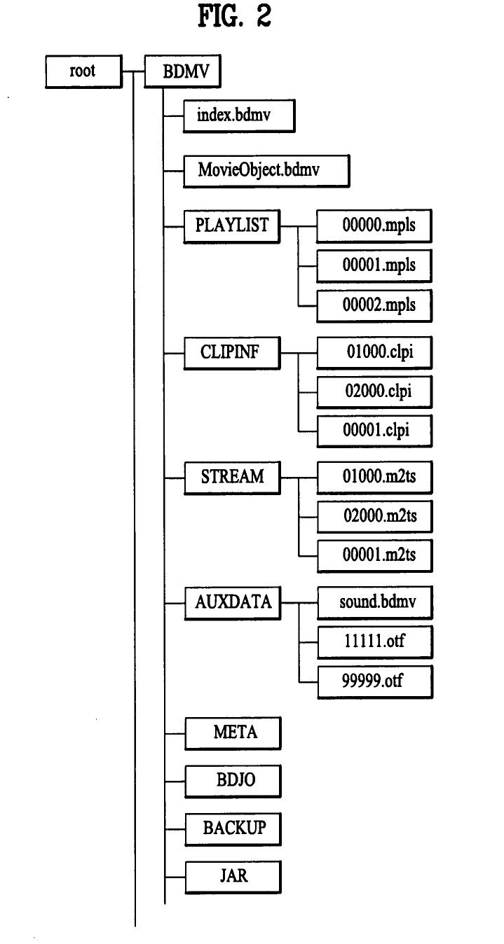

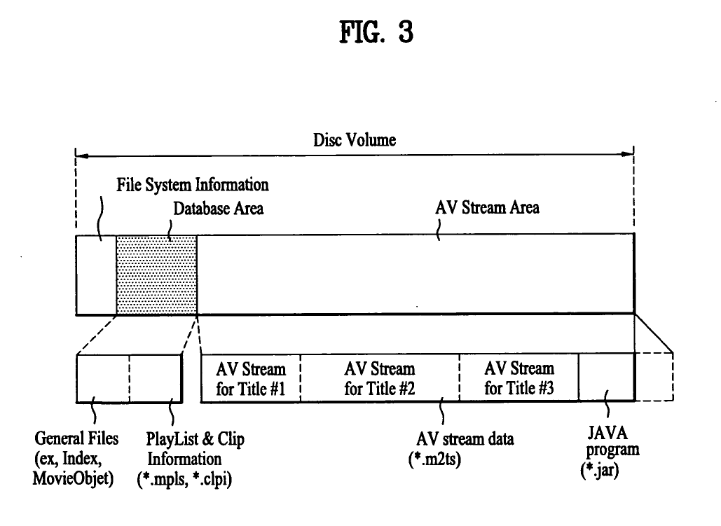

In order to accomplish the request of the user, the original data and additional data must have file structures having a relation therebetween, respectively. Hereinafter, file structures and data recording structures usable in a BD will be described with reference to FIGS. 2 and 3.

FIG. 2 illustrates a file structure for reproduction and management of original data recorded in a BD in accordance with an embodiment of the present invention.

The file structure of the present invention includes a root directory, and at least one BDMV directory BDMV present under the root directory. In the BDMV directory BDMV, there are an index file “index.bdmv” and an object file “MovieObject.bdmv” as general files (upper files) having information for securing an interactivity with the user. The file structure of the present invention also includes directories having information as to the data actually recorded in the disc, and information as to a method for reproducing the recorded data, namely, a playlist directory PLAYLIST, a clip information directory CLIPINF, a stream directory STREAM, an auxiliary directory AUXDATA, a BD-J directory BDJO, a metadata directory META, a backup directory BACKUP, and a JAR directory. Hereinafter, the above-described directories and files included in the directories will be described in detail.

The JAR directory includes JAVA program files.

The metadata directory META includes a file of data about data, namely, a metadata file. Such a metadata file may include a search file and a metadata file for a disc library. Such metadata files are used for efficient search and management of data during the recording and reproduction of data.

The BD-J directory BDJO includes a BD-J object file for reproduction of a BD-J title.

The auxiliary directory AUXDATA includes an additional data file for playback of the disc. For example, the auxiliary directory AUXDATA may include a “Sound.bdmv” file for providing sound data when an interactive graphics function is executed, and “11111.otf” and “99999.otf” files for providing font information during the playback of the disc.

The stream directory STREAM includes a plurality of files of AV streams recorded in the disc according to a particular format. Most generally, such streams are recorded in the form of MPEG-2-based transport packets. The stream directory STREAM uses “*.m2ts” as an extension name of stream files (for example, 01000.m2ts, 02000.m2ts, . . . ). Particularly, a multiplexed stream of video/audio/graphic information is referred to as an “AV stream”. A title is composed of at least one AV stream file.

The clip information (clip-info) directory CLIPINF includes clip-info files 01000.clpi, 02000.clpi, . . . respectively corresponding to the stream files “*.m2ts” included in the stream directory STREAM. Particularly, the clip-info files “*.clpi” are recorded with attribute information and timing information of the stream files “*.m2ts”. Each clip-info file “*.clpi” and the stream file “*.m2ts” corresponding to the clip-info file “*.clpi” are collectively referred to as a “clip”. That is, a clip is indicative of data including both one stream file “*.m2ts” and one clip-info file “*.clpi” corresponding to the stream file “*.m2ts”.

The playlist directory PLAYLIST includes a plurality of playlist files “*.mpls”. “Playlist” means a combination of playing intervals of clips. Each playing interval is referred to as a “playitem”. Each playlist file “*.mpls” includes at least one playitem, and may include at least one subplayitem. Each of the playitems and subplayitems includes information as to the reproduction start time IN-Time and reproduction end time OUT-Time of a particular clip to be reproduced. Accordingly, a playlist may be a combination of playitems.

As to the playlist files, a process for reproducing data using at least one playitem in a playlist file is defined as a “main path”, and a process for reproducing data using one subplayitem is defined as a “sub path”. The main path provides master presentation of the associated playlist, and the sub path provides auxiliary presentation associated with the master presentation. Each playlist file should include one main path. Each playlist file also includes at least one sub path, the number of which is determined depending on the presence or absence of subplayitems. Thus, each playlist file is a basic reproduction/management file unit in the overall reproduction/management file structure for reproduction of a desired clip or clips based on a combination of one or more playitems.

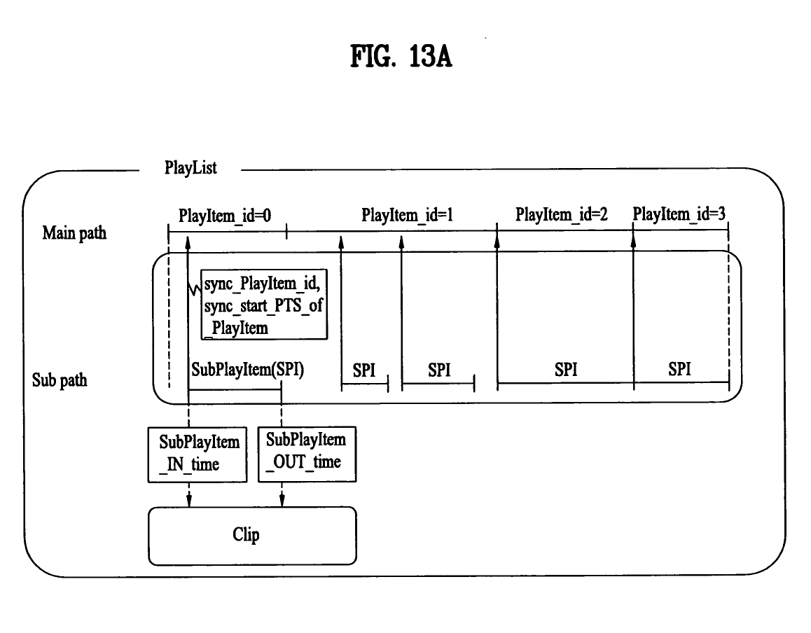

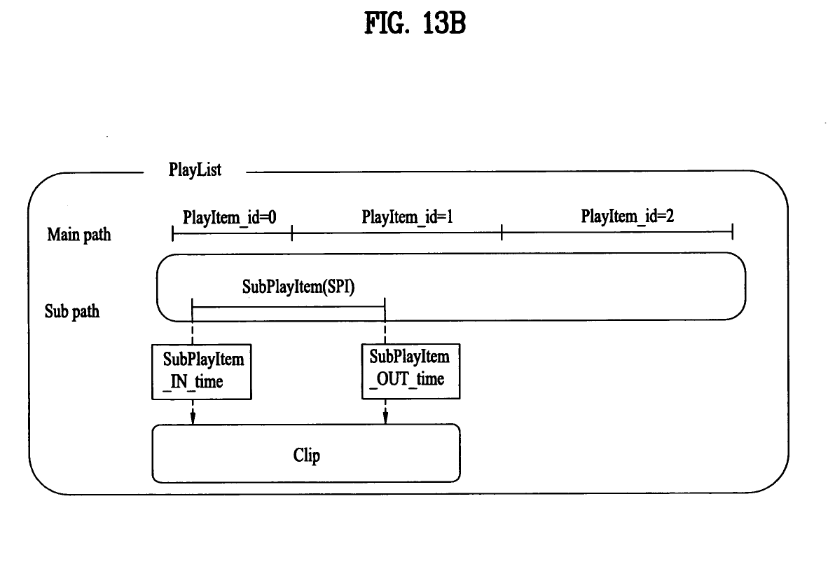

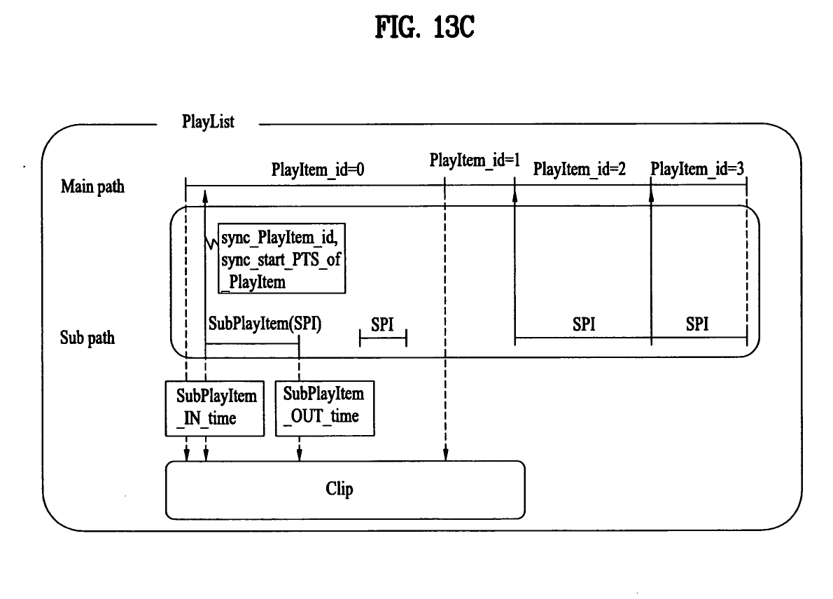

In association with the present invention, video data, which is reproduced through a main path, is referred to as a primary video, whereas video data, which is reproduced through a sub path, is referred to as a secondary video. The function of the optical recording/reproducing apparatus for simultaneously reproducing primary and secondary videos is also referred to as a “picture-in-picture (PiP)”. The sub path can reproduce audio data associated with the primary video or secondary video. The sub path associated with embodiments of the present invention will be described in detail with reference to FIGS. 13A to 13C.

The backup directory BACKUP stores a copy of the files in the above-described file structure, in particular, copies of files recorded with information associated with playback of the disc, for example, a copy of the index file “index.bdmv”, object files “MovieObject.bdmv” and “BD-JObject.bdmv”, unit key files, all playlist files “*.mpls” in the playlist directory PLAYLIST, and all clip-info files “*.clpi” in the clip-info directory CLIPINF. The backup directory BACKUP is adapted to separately store a copy of files for backup purposes, taking into consideration the fact that, when any of the above-described files is damaged or lost, fatal errors may be generated in association with playback of the disc.

Meanwhile, it will be appreciated that the file structure of the present invention is not limited to the above-described names and locations. That is, the above-described directories and files should not be understood through the names and locations thereof, but should be understood through the meaning thereof.

FIG. 3 illustrates a data recording structure of the optical disc according to an embodiment of the present invention. In FIG. 3, recorded structures of information associated with the file structures in the disc are illustrated. Referring to FIG. 3, it can be seen that the disc includes a file system information area recorded with system information for managing the overall file, an area (database area) recorded with the index file, object file, playlist files, clip-info files, and meta files (which are required for reproduction of recorded streams “*.m2ts”), a stream area recorded with streams each composed of audio/video/graphic data or STREAM files, and a JAR area recorded with JAVA program files. The areas are arranged in the above-descried order when viewing from the inner periphery of the disc.

In accordance with the present invention, stream data of a primary video and/or a secondary video is stored in the stream area. The secondary video may be multiplexed in the same stream as the primary video, or may be multiplexed in a stream different from that of the primary video. In accordance with the present invention, a secondary audio associated with the secondary video is multiplexed in the same stream as the primary video, or in a stream different from that of the primary video.

In the disc, there is an area for recording file information for reproduction of contents in the stream area. This area is referred to as a “management area”. The file system information area and database area are included in the management area. The sub path used to reproduce the secondary video may have a sub path type selected from three sub path types based on the kind of the stream in which the secondary video is multiplexed, and whether or not the sub path is synchronous with the main path. The sub path types will be described with reference to FIGS. 13A to 13C. Since the method for reproducing the secondary video and secondary audio is varied depending on the sub path type, the management area includes information as to the sub path type. The areas of FIG. 3 are shown and described only for illustrative purposes. It will be appreciated that the present invention is not limited to the area arrangement of FIG. 3.

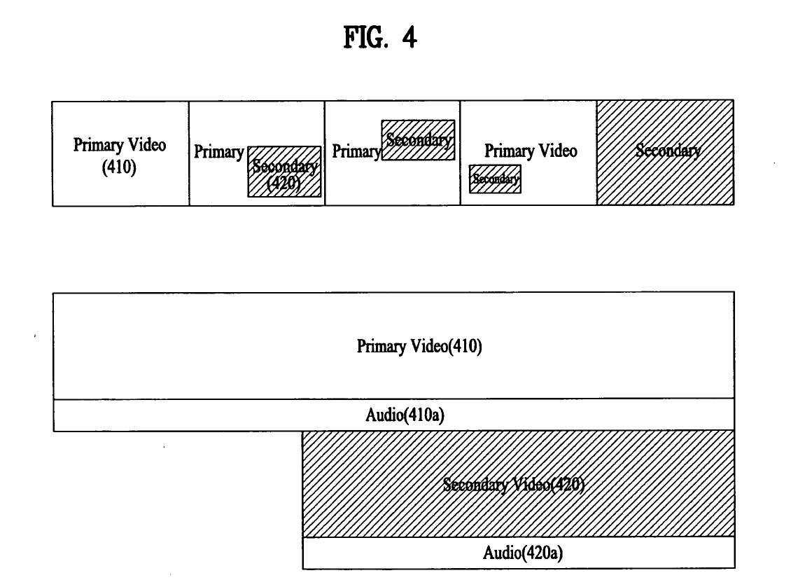

FIG. 4 is a schematic diagram for understanding of the concept of the secondary video according to embodiments of the present invention.

The present invention provides a method for reproducing secondary video data, simultaneously with primary video data. For example, the present invention provides an optical recording/reproducing apparatus that enables a PiP application, and, in particular, effectively performs the PiP application.

During reproduction of a primary video 410 as shown in FIG. 4, it may be necessary to output other video data associated with the primary video 410 through the same display 20 as that of the primary video 410. In accordance with the present invention, such a PiP application can be achieved. For example, during playback of a movie or documentary, it is possible to provide, to the user, the comments of the director or episode associated with the shooting procedure. In this case, the video of the comments or episode is a secondary video 420. The secondary video 420 can be reproduced simultaneously with the primary video 410, from the beginning of the reproduction of the primary video 410.

The reproduction of the secondary video 420 may be begun at an intermediate time of the reproduction of the primary video 410. It is also possible to display the secondary video 420 while varying the position or size of the secondary video 420 on the screen, depending on the reproduction procedure. A plurality of secondary videos 420 may also be implemented. In this case, the secondary videos 420 may be reproduced, separately from one another, during the reproduction of the primary video 410.

The secondary video may be reproduced along with an audio 420a associated with the secondary video. The audio 420a may be output in a state of being mixed with an audio 410a associated with the primary video. Embodiments of the present invention provide methods for reproducing the secondary video along with an audio associated with the secondary video (hereinafter, referred to as a “secondary audio”). Embodiments of the present invention also provide methods for reproducing the secondary audio along with an audio associated with the primary video (hereinafter, referred to as a “primary audio”).

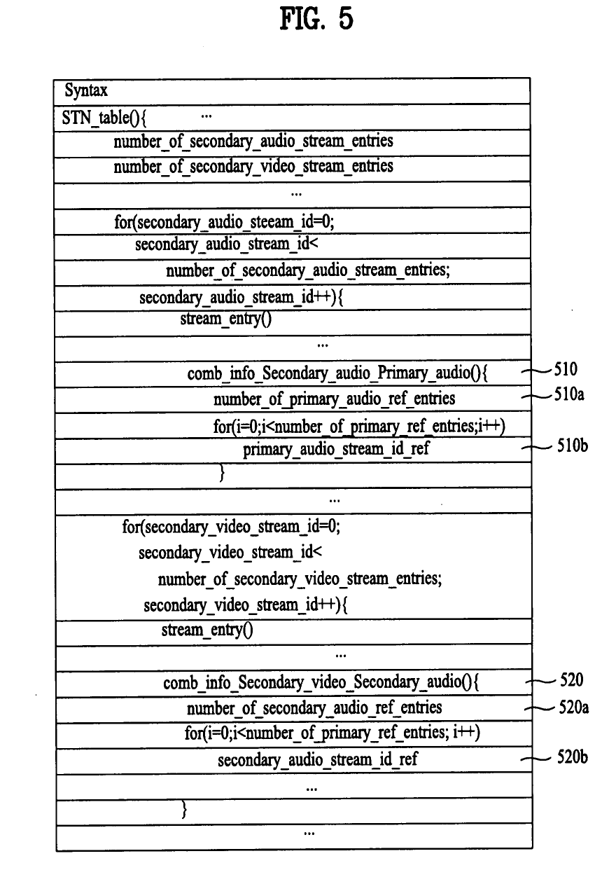

In this regard, in accordance with the present invention, information as to a combination of the secondary video and secondary audio allowed to be simultaneously reproduced (hereinafter, referred to as “secondary video/secondary audio combination information) is included in the management data for the secondary video. Also, embodiments of the present invention provide information defining the primary audio allowed to be mixed with the secondary audio, and provide for reproducing the secondary audio along with the primary audio using the information. The management data may include metadata as to the secondary video, a table (hereinafter, referred to as an “STN table”) defining at least one stream entry of the secondary video, and a clip information file as to the stream in which the secondary video is multiplexed. Hereinafter, the case in which the combination information is included in the STN table will be described with reference to FIG. 5.

FIG. 5 illustrates an exemplary embodiment of a table including stream entries of the secondary video.

The table (hereinafter, referred to as an “STN table”) defines a list of elementary streams selectable by the optical recording/reproducing apparatus during the presentation of the current playitem and sub paths associated with the current playitem. The elementary streams of the main clip and the sub paths that have an entry in the STN table may be at the content provider's discretion.

The optical recording/reproducing apparatus of the present invention has functions for processing the primary video, primary audio, secondary video, and secondary audio. Accordingly, the STN table of the present invention stores the entries associated with the primary video, primary audio, secondary video, and secondary audio.

Referring to FIG. 5, the STN table includes a value indicating the secondary video stream number corresponding to the video stream entry associated with the value of ‘secondary_video_stream_id’. The value of ‘secondary_video_stream_id’ is initially set to ‘0’, and is incremented by ‘1’ unless the value of ‘secondary_video_stream_id’ is equal to the number of secondary video streams, namely, the value of ‘number_of_secondary_video_stream_entries’. Accordingly, the secondary video stream number is equal to a value obtained by adding ‘1’ to the value of ‘secondary_video stream_id’.

A stream entry block is defined in the STN table in accordance with the above-described ‘secondary_video_stream_id’. The stream entry block includes the type of database for identifying an elementary stream referred to by the stream number for the stream entry. In accordance with an embodiment of the present invention, the stream entry block may include information for identifying the sub path associated with the reproduction of the secondary video, and information for identifying the sub clip entry defined in the subplayitem of the sub path referred to by the sub path identifying information. Thus, the stream entry block functions to indicate a source of the secondary audio stream to be reproduced.

In accordance with the present invention, the STN table also includes secondary video/secondary audio combination information 520 corresponding to ‘secondary_video_stream_id’. The secondary video/secondary audio combination information 520 defines secondary audio allowed to be reproduced with the secondary video. Referring to FIG. 5, the secondary video/secondary audio combination information 520 includes the number of secondary audio streams 520a allowed to be reproduced along with the secondary video and information 520b identifying the secondary audio streams. In accordance with an embodiment of the present invention, one of the secondary audio streams defined by the secondary video/secondary audio combination information 520 is reproduced along with the secondary video, so as to be provided to the user.

In accordance with the present invention, the STN table also includes primary audio information 510 defining primary audio allowed to be mixed with the secondary audio. Referring to FIG. 5, the primary audio information 510 includes the number of primary audio streams 510a allowed to be mixed with the secondary audio, and information 510b identifying the primary audio streams. In accordance with the present invention, one of the primary audio streams defined by the primary audio information 510 is reproduced in state of being mixed with the secondary audio, so as to be provided to the user.

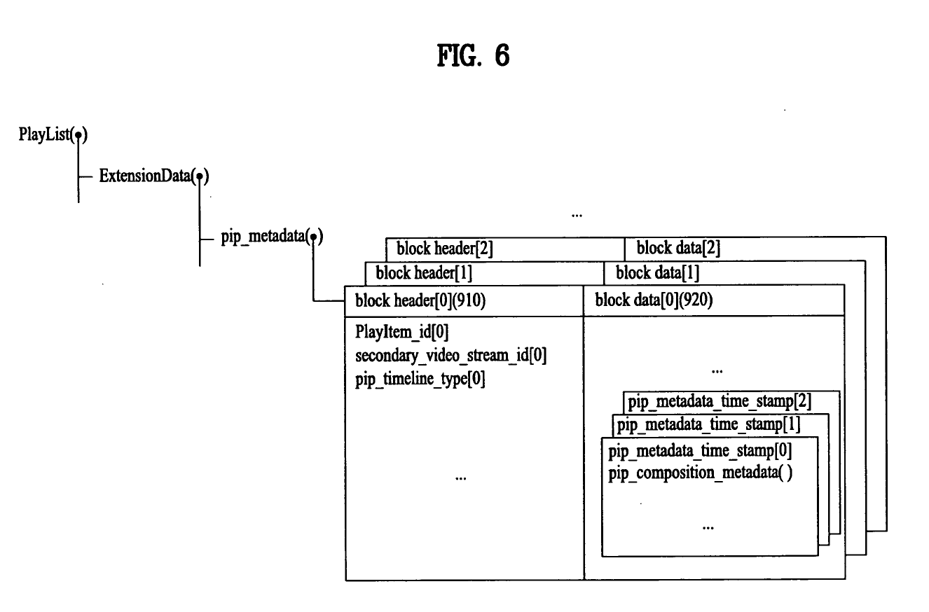

FIG. 6 illustrates an exemplary embodiment of the secondary video metadata according to the present invention. The playitem including the above-described STN table, and streams associated with reproduction of the secondary video can be identified using the secondary video metadata.

In accordance with an embodiment of the present invention, reproduction of the secondary video is managed using metadata. The metadata includes information about the reproduction time, reproduction size, and reproduction position of the secondary video. Hereinafter, the management data will be described in conjunction with an example in which the management data is PiP metadata.

The PiP metadata may be included in a playlist which is a kind of a reproduction management file. FIG. 6 illustrates PiP metadata blocks included in an ‘ExtensionData’ block of a playlist managing reproduction of the primary video. Of course, the information may be included in headers of secondary video streams implementing PiP.

The PiP metadata may include at least one block header ‘block_header[k]’ 910 and block data ‘block_data[k]’ 920. The number of the block header and block data is determined depending on the number of metadata block entries included in PiP metadata blocks. The block header 910 includes header information of the associated metadata block. The block data 920 includes information of the associated metadata block.

The block header 910 may include a field indicating playitem identifying information (hereinafter, referred to as ‘PlayItem_id[k]’), and a field indicating secondary video stream identifying information (hereinafter, referred to as ‘secondary_video_stream_id[k]’). The information ‘PlayItem_id[k]’ has a value for a playitem of which the STN table contains ‘secondary_video_stream_id’ entry that is referred to by ‘secondary_video_stream_id[k]’. The value of ‘PlayItem_id[k]’ is given in the playlist block of the playlist file. In one embodiment, in the PiP metadata, the entries of the ‘PlayItem_id’ value in the PiP metadata are sorted in an ascending order of the ‘PlayItem_id’ value. The information ‘secondary_video_stream_id[k]’ is used to identify a sub path, and a secondary video stream to which the associated block data 920 is applied. As the stream corresponding to ‘secondary_video_stream_id[k]’ included in the STN table of the playitem ‘PlayItem’ corresponding to ‘PlayItem_id[k] is reproduced, the secondary video is provided to the user.

In accordance with an embodiment of the present invention, the secondary audio defined by the secondary video/secondary audio combination information corresponding to ‘secondary_video_stream_id[k]’ is reproduced along with the secondary video. Also, the primary audio defined by the secondary audio/primary audio combination information associated with the secondary audio is output mixed with the secondary audio.

In addition, the block header 910 may include information indicating a timeline referred to by associated PiP metadata (hereinafter, referred to as a “PiP timeline type ‘pip_timeline_type’”). The type of the secondary video provided to the user is varied depending on the PiP timeline type. Information ‘pip_composition_metadata’ is applied to the secondary video along the timeline determined in accordance with the PiP timeline type. The information ‘pip_composition_metadata’ is information indicating the reproduction position and size of the secondary video. The information ‘pip_composition_metadata’ may include position information of the secondary video, and size information of the secondary video (hereinafter, referred to as ‘pip_scale[i]’). The position information of the secondary video includes horizontal position information of the secondary video (hereinafter, referred to as ‘pip_horizontal_position[i]’), and vertical position information of the secondary video (hereinafter, referred to as ‘pip_vertical_position[i]’). The information ‘pip_horizontal_position[i]’ indicates a horizontal position of the secondary video displayed on a screen when viewing from an origin of the screen, and the information ‘pip_vertical_position[i]’ indicates a vertical position of the secondary video displayed on the screen when viewing from the origin of the screen. The display size and position of the secondary video on the screen are determined by the size information and position information.

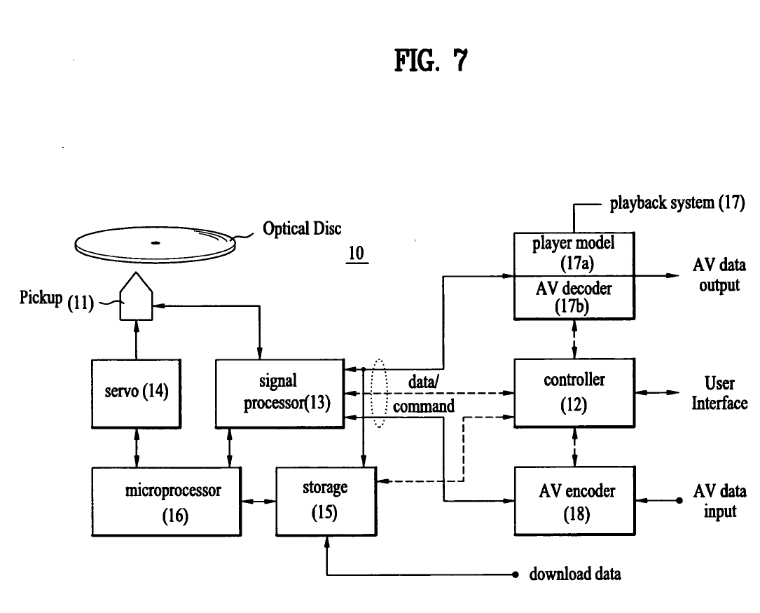

FIG. 7 illustrates an exemplary embodiment of the overall configuration of the optical recording/reproducing apparatus 10 according to the present invention. Hereinafter, reproduction and recording of data according to the present invention will be described with reference to FIG. 7.

As shown in FIG. 7, the optical recording/reproducing apparatus 10 mainly includes a pickup 11, a servo 14, a signal processor 13, and a microprocessor 16. The pickup 11 reproduces original data and management data recorded in an optical disc. The management data includes reproduction management file information. The servo 14 controls operation of the pickup 11. The signal processor 13 receives a reproduced signal from the pickup 11, and restores the received reproduced signal to a desired signal value. The signal processor 13 also modulates signals to be recorded, for example, primary and secondary videos, to corresponding signals recordable in the optical disc, respectively. The microprocessor 16 controls the operations of the pickup 11, the servo 14, and the signal processor 13. The pickup 11, the servo 14, the signal processor 13, and the microprocessor 16 are also collectively referred to as a “recording/reproducing unit”. In accordance with the present invention, the recording/reproducing unit reads data from an optical disc 30 or a storage 15 under the control of a controller 12, and sends the read data to an AV decoder 17b. That is, from a viewpoint of reproduction, the recording/reproducing unit functions as a reader unit for reading data. The recording/reproducing unit also receives an encoded signal from an AV encoder 18, and records the received signal in the optical disc 30. Thus, the recording/reproducing unit can record video and audio data in the optical disc 30.

The controller 12 may download additional data present outside the optical disc 30 in accordance with a user command, and store the additional data in the storage 15. The controller 12 also reproduces the additional data stored in the storage 15 and/or the original data in the optical disc 30 at the request of the user.

In accordance with the present invention, the controller 12 performs a control operation for selecting a secondary audio to be reproduced along with a secondary video, based on secondary video/secondary audio combination information associated with the secondary video. The controller 12 performs a control operation for selecting a primary audio to be mixed with the secondary audio, based on primary audio information indicating primary audios allowed to be mixed with the secondary audio. Also, the optical recording/reproducing apparatus 10 of the present invention operates to record data in the recording medium, namely, the optical disc 30. Here, the controller 12 produces management data including the above-described combination information, and performs a control operation for recording the management data on the optical disc 30.

The optical recording/reproducing apparatus 10 further includes a playback system 17 for finally decoding data, and providing the decoded data to the user under the control of the controller 12. The playback system 17 includes an AV decoder 17b for decoding an AV signal. The playback system 17 also includes a player model 17a for analyzing an object command or application associated with playback of a particular title, analyzing a user command input via the controller 12, and determining a playback direction, based on the results of the analysis. In an embodiment, the player model 17a may be implemented as including the AV decoder 17b. In this case, the playback system 17 is the player model itself. The AV decoder 17b may include a plurality of decoders respectively associated with different kinds of signals.

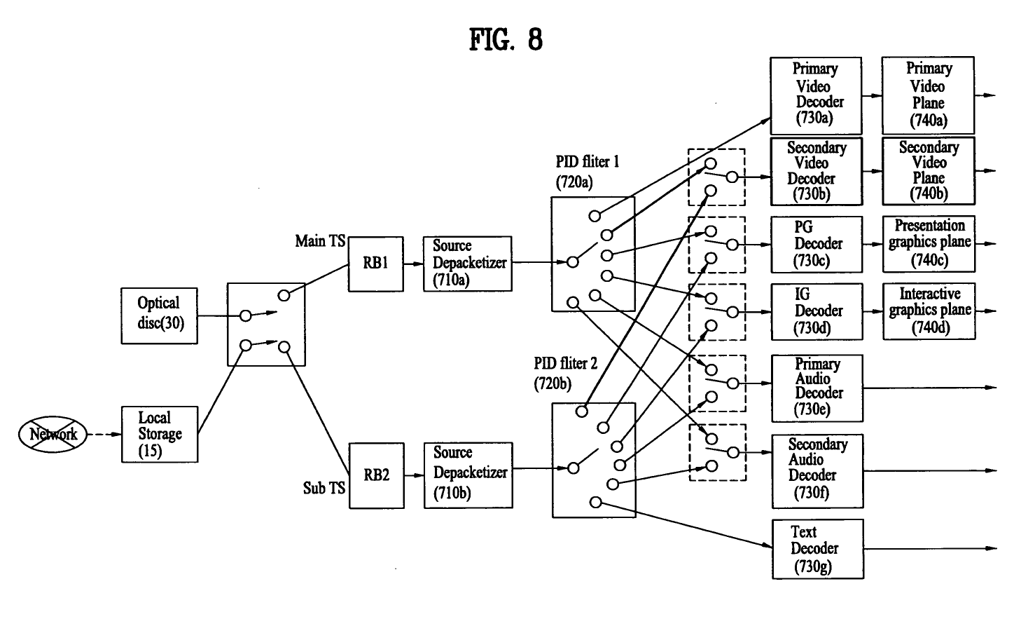

FIG. 8 schematically illustrates the AV decoder model according to the present invention. In accordance with the present invention, the AV decoder 17b includes a secondary video decoder 730b for simultaneous reproduction of the primary and secondary videos, namely, implementation of a PiP application. The secondary video decoder 730b decodes the secondary video. The secondary video may be recorded in the recording medium 30 in an AV stream, to be provided to the user. The secondary video may also be provided to the user after being downloaded from outside of the recording medium 30. The AV stream is provided to the AV decoder 17b in the form of a transport stream (TS).

In the present invention, the AV stream, which is reproduced through a main path, is referred to as a main transport stream (hereinafter, referred to as a “main stream” or main TS), and an AV stream other than the main stream is referred to as a sub transport stream (hereinafter, referred to as a “sub stream” or sub TS). In accordance with the present invention, the secondary video may be multiplexed in the same video as the primary video. In this case, the secondary video is provided to the AV decoder 17b as a main stream. In the AV decoder 17b, the main stream passes through a switching element to a buffer RB1, and the buffered main stream is depacketized by a source depacketizer 710a. Data included in the depacketized AV stream is provided to an associated one of decoders 730a to 730g after being separated from the depacketized AV stream in a packet identifier (PID) filter-1 720a in accordance with the kind of the data packet. That is, where a secondary video is included in the main stream, the secondary video is separated from other data packets in the main stream by the PID filter-1 720a, and is then provided to the secondary video decoder 730b. As shown, packets from the PID filter-1 720a may pass through another switching element before receipt by the decoders 730b-730g.

In accordance with the present invention, the secondary video may also be multiplexed in a stream different from that of the primary video. For example, the secondary video may be stored as a separate file on the recording medium 30 or stored in the local storage 15 (e.g., after being downloaded from the internet). In this case, the secondary video is provided to the AV decoder 17b as a sub stream. In the AV decoder 17b, the sub stream passes through a switching element to a buffer RB2, and the buffered sub stream is depacketized by a source depacketizer 710b. Data included in the depacketized AV stream is provided to an associated one of decoders 730a to 730g after being separated from the depacketized AV stream in a PID filter-2 720b in accordance with the kind of the data packet. That is, where a secondary video is included in the sub stream, the secondary video is separated from other data packets in the sub stream by the PID filter-2 720b, and is then provided to the secondary video decoder 730b. As shown, packets from the PID filter-2 720b may pass through another switching element before receipt by the decoders 730b-730f.

In accordance with the present invention, the secondary audio may be multiplexed in the same stream as the secondary video. Accordingly, similar to the secondary video, the secondary audio is provided to the AV decoder 17b as a main stream, or as sub stream. In the AV decoder 17b, the secondary audio is separated from the main stream or sub stream in the PID filter-1 720a or PID filter-2 720b after passing through the source depacketizer 710a or 710b, and is then provided to the secondary audio decoder 730f. The secondary audio decoded in the secondary audio decoder 730f is provided to an audio mixer (described below), and is then output from the audio mixer after being mixed with a primary audio decoded in the primary audio decoder 730e.

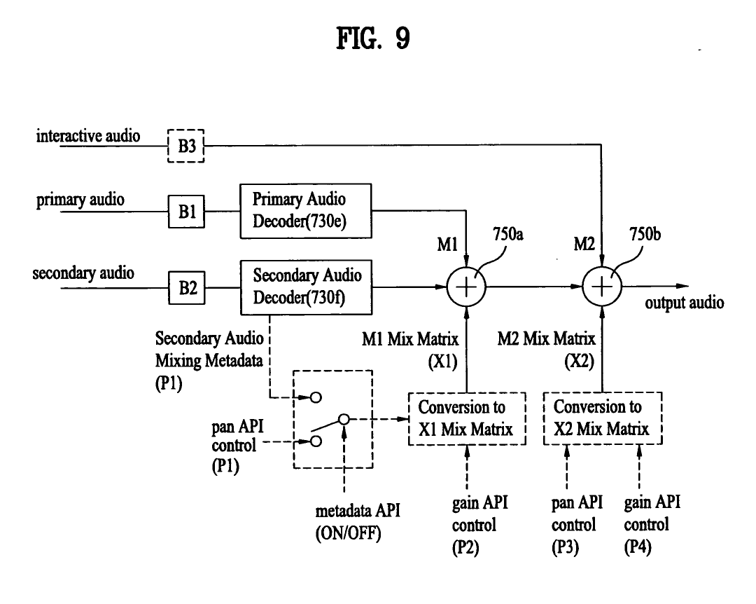

FIG. 9 illustrates the overall configuration of an audio mixing model according to the present invention.

In the present invention, “audio mixing” means that the secondary audio is mixed with the primary audio and/or an interactive audio. In order to perform the decoding and mixing operation, the audio mixing model according to an embodiment of the present invention includes two audio decoders 730e and 730f, and two audio mixers 750a and 750b. The content provider controls an audio mixing process carried out by the audio mixing model, using audio mixing control parameters P1, P2, P3, and P4.

Generally, the primary audio is associated with the primary video, and may be, for example, a movie sound track included in the recording medium. However, the primary audio may instead be stored in the storage 15 after being downloaded from a network. In accordance with one embodiment of the present invention, the primary audio is multiplexed with the primary video, and is provided to the AV decoder 17b as part of a main stream. The primary audio transport stream (TS) is separated from the main stream by the PID filter-1 720a, based on a PID, and is then provided to the primary audio decoder 730e via a buffer B1.

In accordance with an embodiment of the present invention, the secondary audio may be audio to be reproduced synchronously with the secondary video. The secondary audio is defined by the secondary video/secondary audio combination information. The secondary audio may be multiplexed with the secondary video, and may be provided to the AV decoder 17b as a main stream, or as a sub stream. The secondary audio transport stream (TS) is separated from the main stream or sub stream by the PID filter-1 720a or PID filter-2 720b, respectively, and is then provided to the secondary audio decoder 730f via a buffer B2. As will be discussed in detail below, the primary audio and secondary audio output by the primary audio decoder 730e and the secondary audio decoder 730f, respectively, are mixed by the primary audio mixer M1 750a.

The interactive audio may be a linear-pulse-code-modulated (LPCM) audio which is activated in accordance with an associated application. The interactive audio may be provided to the secondary audio mixer 750b, to be mixed with the mixed output from the primary audio mixer 750a. The interactive audio stream may be present in the storage 15 or recording medium 30. Generally, the interactive audio stream is used to provide dynamic sound associated with an interactive application, for example, button sound.

The above-described audio mixing model operates on the basis of a linear pulse code modulation (LPCM) mixing. That is, audio data is mixed after being decoded in accordance with an LPCM scheme. The primary audio decoder 730e decodes a primary audio stream in accordance with the LPCM scheme. The primary audio decoder 730e may be configured to decode or down-mix all channels included in a primary audio sound track. The secondary audio decoder 730f decodes a secondary audio stream in accordance with the LPCM scheme. The secondary audio decoder 730f extracts mixing data included in the secondary audio stream, converts the extracted data to a mix matrix format, and sends the resultant mix matrix to the primary audio mixer (M1) 750a. This metadata may be used to control the mixing process. The secondary audio decoder 730f may be configured to decode or down-mix all channels included in a secondary audio sound track. Each decoded channel output from the secondary audio decoder 730f may be mixed with at least one channel output from the primary audio decoder 730e.

The mix matrix is made in accordance with mixing parameters provided from content providers. The mix matrix includes coefficients to be applied to each channel of audio in order to control mixing levels of the audios before summing.

The mixing parameters may include a parameter P1 used for panning of the secondary audio stream, a parameter P2 used for controlling the mixing levels of the primary and secondary audio streams, a parameter P3 used for panning of the interactive audio stream, and a parameter P4 used for controlling the mixing level of the interactive audio stream. The parameters are not limited to the names thereof. It will be appreciated that there may be an additional parameters produced by combining the above-described parameters or by separating one or more parameters from the above-described parameters in terms of function.

In accordance with the present invention, a command set may be used as a source of the mixing parameters. That is, the optical recording/reproducing apparatus 10 of the present invention may control mixing of the primary audio with the secondary audio to be reproduced along with the secondary video, using the command set. A “command set,” for example, may be a program bundle for using functions of application programs executed in the optical recording/reproducing apparatus. The functions of the application programs are interfaced with the functions of the optical recording/reproducing apparatus by the command set. Thus, it is possible to use various functions of the optical recording/reproducing apparatus in accordance with the command set. The command set may be stored in the recording medium, to be provided to the optical recording/reproducing apparatus. Of course, the command set may be equipped in the optical recording/reproducing apparatus in the manufacturing stage of the optical recording/reproducing apparatus. A representative example of a command set is an application programming interface (API). Mixing metadata may be used as a source of the mixing parameters. The mixing metadata is provided to the secondary audio decoder 730b in the secondary audio. The following description will be given in conjunction with the case in which an API is used as the command set.

In accordance with an embodiment of the present invention, the secondary audio is panned using a command set such as an API. Also, the mixing level of the primary audio or secondary audio is controlled using the command set. The system software of the optical recording/reproducing apparatus 10 translates the command set to an X1 mix matrix, and sends the X1 mix matrix to the primary audio mixer 750a. For example, the parameters P1 and P2 are stored by the controller 12 of FIG. 9 such as in the storage 15, and converted by the controller 12 according to the player model 17a into the mix matrix X1 for use by the mixer M1 in the playback system 17. The mixed output from the primary audio mixer 750a may be mixed with an interactive audio in the secondary audio mixer 750b. The mixing process carried out in the secondary audio mixer 750b can be controlled by the command set as well. In this case, the command set is converted to an X2 mix matrix, and sends the X2 mix matrix to the secondary audio mixer 750b. For example, the parameters P3 and P4 are stored by the controller 12 of FIG. 9 such as in the storage 15, and converted by the controller 12 according to the player model 17a into the mix matrix X2 for use by the mixer M2 in the playback system 17.

The X1 mix matrix is controlled by both the mixing parameters P1 and P2. That is, the parameters P1 and P2 simultaneously send commands to the X1 mix matrix. Accordingly, the primary audio mixer M1 is controlled by the X1 mix matrix. The mixing parameter P1 is provided from the API or secondary video decoder. On the other hand, the mixing parameter P2 is provided from the API.

In the audio mixing model according to an embodiment of the present invention, it is possible to turn on and off the processing of the audio mixing metadata from a secondary audio stream, using a metadata ON/OFF API. When the mixing metadata is ON, the mixing parameter P1 comes from the secondary audio decoder 730f. When the mixing metadata is OFF, the mixing parameter P1 comes from the API. Meanwhile, in this embodiment, the audio mixing level control provided through the mixing parameter P2 is applied to the mix matrix formed using the mixing parameter P1. Accordingly, when the metadata control is ON, both the mixing metadata and command set control the audio mixing process.

Meanwhile, the AV encoder 18, which is also included in the optical recording/reproducing apparatus 10 of the present invention, converts an input signal to a signal of a particular format, for example, an MPEG2 transport stream, and sends the converted signal to the signal processor 13, to enable recording of the input signal in the optical disc 30. In accordance with the present invention, the AV encoder 18 encodes the secondary audio associated with the secondary video in the same stream as the secondary video. The secondary video may be encoded in the same stream as the primary video, or may be encoded in a stream different from that of the primary video.

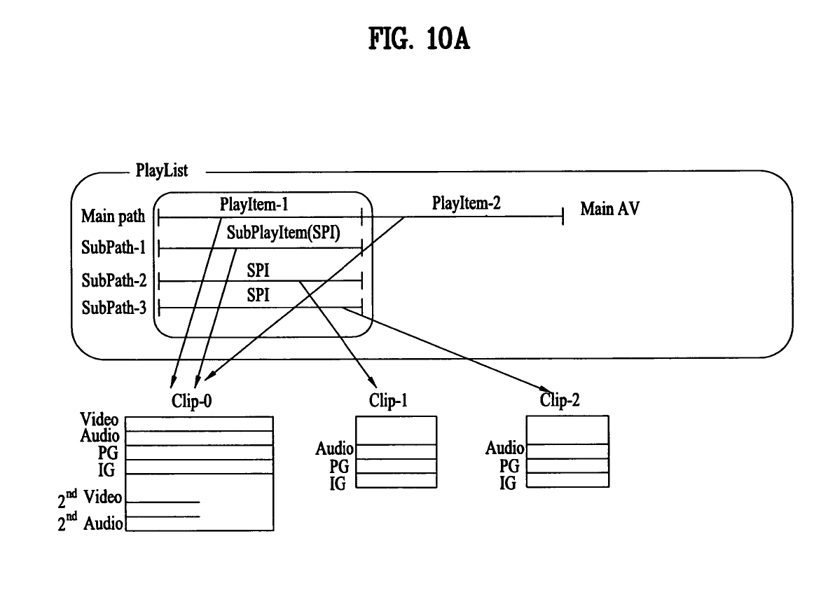

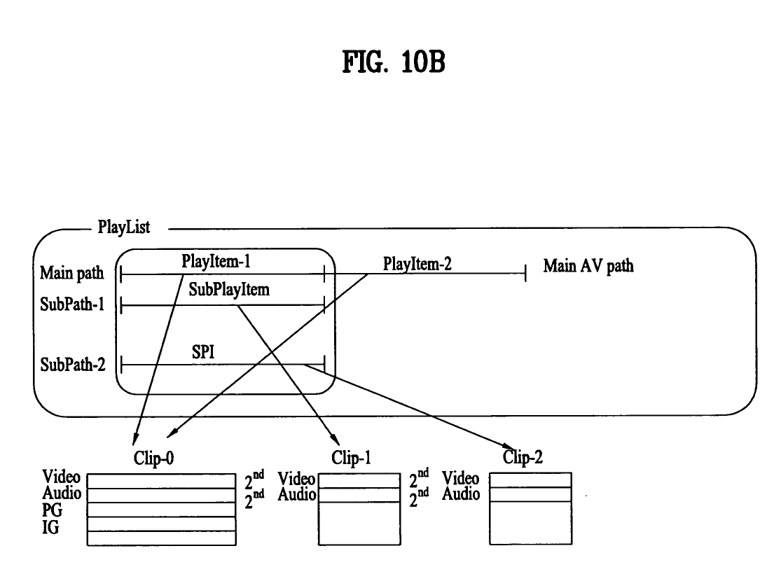

FIGS. 10A and 10B illustrates embodiments of a data encoding method according to the present invention. FIG. 10A illustrates the case in which the secondary video and secondary audio are encoded in the same stream as the primary video. The case in which data is encoded in the same stream as the primary video, namely, a main stream, is referred to as an ‘in-mux’ type. In the embodiment of FIG. 10A, the playlist includes one main path and three sub paths. The main path is a presentation path of a main video/audio, and each sub path is a presentation path of a video/audio additional to the main video/audio. Playitems ‘PlayItem-1’ and ‘PlayItem-2’ configuring the main path refer to associated clips to be reproduced, and playing intervals of the clips, respectively. In the STN table of each playitem, elementary streams are defined which are selectable by the optical recording/reproducing apparatus of the present invention during the reproduction of the playitem. The playitems ‘PlayItem-1’ and ‘PlayItem-2’ refer to a clip ‘Clip-0’. Accordingly, the clip ‘Clip-0’ is included for the playing intervals of the playitems ‘PlayItem-1’ and ‘PlayItem-2’. Since the clip ‘Clip-0’ is reproduced through the main path, the clip ‘Clip-0’ is provided to the AV decoder 17b as a main stream.

Each of the sub paths ‘SubPath-1’, ‘SubPath-2’, and ‘SubPath-3’ associated with the main path is configured by a respective subplayitem. The subplayitem of each sub path refers to a clip to be reproduced. In the illustrated case, the sub path ‘SubPath-1’ refers to the clip ‘Clip-0’, the sub path ‘SubPath-2’ refers to a clip ‘Clip-1’, and the sub path ‘SubPath-3’ refers to a clip ‘Clip-2’. That is, the sub path ‘SubPath-1’ uses secondary video and audio streams included in the clip ‘Clip-0’. On the other hand, each of the sub paths ‘SubPath-2’ and ‘SubPath-3’ uses audio, PG, and IG streams included in the clip referred to by the associated subplayitem.

In the embodiment of FIG. 10A, the secondary video and secondary audio are encoded in the clip ‘Clip-0’ to be reproduced through the main path. Accordingly, the secondary video and secondary audio are provided to the AV decoder 17b, along with the primary video, as a main stream, as shown in FIG. 8. In the AV decoder 17b, the secondary video and secondary audio are provided to the secondary video decoder 730b and secondary audio decoder 730f via the PID filter-1 720a, respectively, and are then decoded by the secondary video decoder 730b and secondary audio decoder 730f, respectively. In addition, the primary video of the clip ‘Clip-0’ is decoded in the primary video decoder 730a, and the primary audio is decoded in the primary audio decoder 730e. Also, the PG, IG, and secondary audio are decoded in the PG decoder 730c, IG decoder 730d, and secondary audio decoder 730f, respectively. When the decoded primary audio is defined in the STN table as being allowed to be mixed with the secondary audio, the decoded primary audio is provided to the primary audio mixer 750a, to be mixed with the secondary audio. As described above, the mixing process in the primary audio mixer can be controlled by the command set.

FIG. 10B illustrates the case in which the secondary video and secondary audio are encoded in a stream different from that of the primary video. The case in which data is encoded in a stream different from that of the primary video, namely, a sub stream, is referred to as an ‘out-of-mux’ type. In the embodiment of FIG. 10B, the playlist includes one main path and two sub paths ‘SubPath-1’ and ‘SubPath-2’. Playitems ‘PlayItem-1’ and ‘PlayItem-2’ are used to reproduce elementary streams included in a clip ‘Clip-0’. Each of the sub paths ‘SubPath-1’ and ‘SubPath-2’ is configured by a respective subplayitem. The subplayitems of the sub paths ‘SubPath-1’ and ‘SubPath-2’ refer to clips ‘Clip-1’ and ‘Clip-2’, respectively. When the sub path ‘SubPath-1’ is used along with the main path, for reproduction of streams, the secondary video referred to by the sub path ‘SubPath-1’ is reproduced along with the video (primary video) referred to by the main path. On the other hand, when the sub path ‘SubPath-2’ is used along with the main path, for reproduction of streams, the secondary video referred to by the sub path ‘SubPath-2’ is reproduced along with the primary video referred to by the main path.

In the embodiment of FIG. 10B, the secondary video is included in a stream other than the stream which is reproduced through the main path. Accordingly, streams of the encoded secondary video, namely, the clips ‘Clip-1’ and ‘Clip-2’, are provided to the AV decoder 17b as sub streams, as shown in FIG. 8. In the AV decoder 17b, each sub stream is depacketized by the source depacketizer 710b. Data included in the depacketized AV stream is provided to an associated one of the decoders 730a to 730g after being separated from the depacketized AV stream in the PID filter-2 720b in accordance with the kind of the data packet. For example, when ‘SubPath-1’ is presented with the main path, for reproduction of streams, the secondary video included in the clip ‘Clip-1’ is provided to the secondary video decoder 730b after being separated from secondary audio packets, and is then decoded by the secondary video decoder 730b. In this case, the secondary audio is provided to the secondary audio decoder 730f, and is then decoded by the secondary audio decoder 730f. The decoded secondary video is displayed on the primary video, which is displayed after being decoded by the primary video decoder 730a. Accordingly, the user can view both the primary and secondary videos through the display 20.

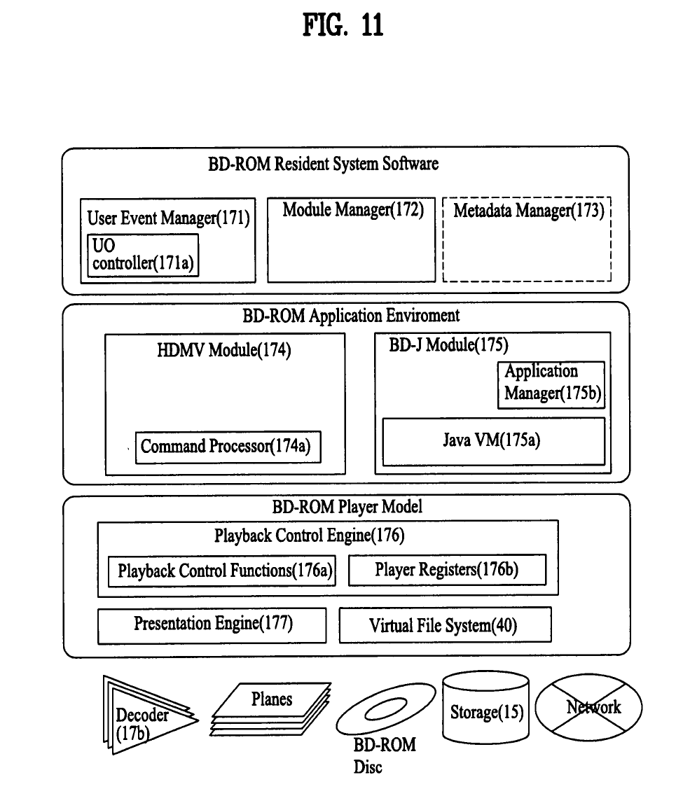

FIG. 11 is a schematic diagram explaining the playback system according to an embodiment of the present invention.

“Playback system” means a collective of reproduction processing means which are configured by programs (software) and/or hardware provided in the optical recording/reproducing apparatus. That is, the playback system is a system which can not only play back a recording medium loaded in the optical recording/reproducing apparatus 10, but also can reproduce and manage data stored in the storage 15 in association with the recording medium (for example, after being downloaded from the outside of the recording medium).

In particular, the playback system 17 includes a user event manager 171, a module manager 172, a metadata manager 173, an HDMV module 174, a BD-J module 175, a playback control engine 176, a presentation engine 177, and a virtual file system 40. This configuration will be described in detail, hereinafter.

As a separate reproduction processing/managing means for reproduction of HDMV titles and BD-J titles, the HDMV module 174 for HDMV titles and the BD-J module 175 for BD-J titles are constructed independently of each other. Each of the HDMV module 174 and BD-J module 175 has a control function for receiving a command or program included in the associated object “Movie Object” or “BD-J Object”, and processing the received command or program. Each of the HDMV module 174 and BD-J module 175 can separate an associated command or application from the hardware configuration of the playback system, to enable portability of the command or application. For reception and processing of the command, the HDMV module 174 includes a command processor 174a. For reception and processing of the application, the BD-J module 175 includes a Java virtual machine (VM) 175a, and an application manager 175b.

The Java VM 175a is a virtual machine in which an application is executed. The application manager 175b includes an application management function for managing the life cycle of an application processed in the BD-J module 175.

The module manager 172 functions not only to send user commands to the HDMV module 174 and BD-J module 175, respectively, but also to control operations of the HDMV module 174 and BD-J module 175. A playback control engine 176 analyzes the playlist file information recorded in the disc in accordance with a playback command from the HDMV module 174 or BD-J module 175, and performs a playback function based on the results of the analysis. The presentation engine 177 decodes a particular stream managed in association with reproduction thereof by the playback control engine 176, and displays the decoded stream in a displayed picture. In particular, the playback control engine 176 includes playback control functions 176a for managing all playback operations, and player registers 176b for storing information as to the playback status and playback environment of the player. In some cases, the playback control functions 176a mean the playback control engine 176 itself.

The HDMV module 174 and BD-J module 175 receive user commands in independent manners, respectively. The user command processing methods of HDMV module 174 and BD-J module 175 are also independent of each other. In order to transfer a user command to an associated one of the HDMV module 174 and BD-J module 175, a separate transfer means should be used. In accordance with the present invention, this function is carried out by the user event manager 171. Accordingly, when the user event manager 171 receives a user command generated through a user operation (UO) controller 171a, the user event manager sends the received user command to the module manager 172 or UO controller 171a. On the other hand, when the user event manager 171 receives a user command generated through a key event, the user event manager sends the received user command to the Java VM 175a in the BD-J module 175.

The playback system 17 of the present invention may also include a metadata manager 173. The metadata manager 173 provides, to the user, a disc library and an enhanced search metadata application. The metadata manager 173 can perform selection of a title under the control of the user. The metadata manager 173 can also provide, to the user, recording medium and title metadata.

The module manager 172, HDMV module 174, BD-J module 175, and playback control engine 176 of the playback system according to the present invention can perform desired processing in a software manner. Practically, the processing using software is advantageous in terms of design, as compared to processing using a hardware configuration. Of course, it is general that the presentation engine 177, decoder 19, and planes are designed using hardware. In particular, the constituent elements (for example, constituent elements designated by reference numerals 172, 174, 175, and 176), each of which performs desired processing using software, may constitute a part of the controller 12. Therefore, it should be noted that the above-described constituents and configuration of the present invention be understood on the basis of their meanings, and are not limited to their implementation methods such as hardware or software implementation.

Here, “plane” means a conceptual model for explaining overlaying processes of the primary video, secondary video, presentation graphics (PG), interactive graphics (IG), and text sub titles. In accordance with the present invention, a secondary video plane 740b is arranged in front of a primary video plane 740a. Accordingly, the secondary video output after being decoded is displayed on the secondary video plane 740b. Graphic data decoded by the presentation graphic decoder (PG decoder) 730c and/or text decoder 730g is output from a presentation graphic plane 740c. Graphic data decoded by the interactive graphic decoder 730d is output from an interactive graphic plane 740d.

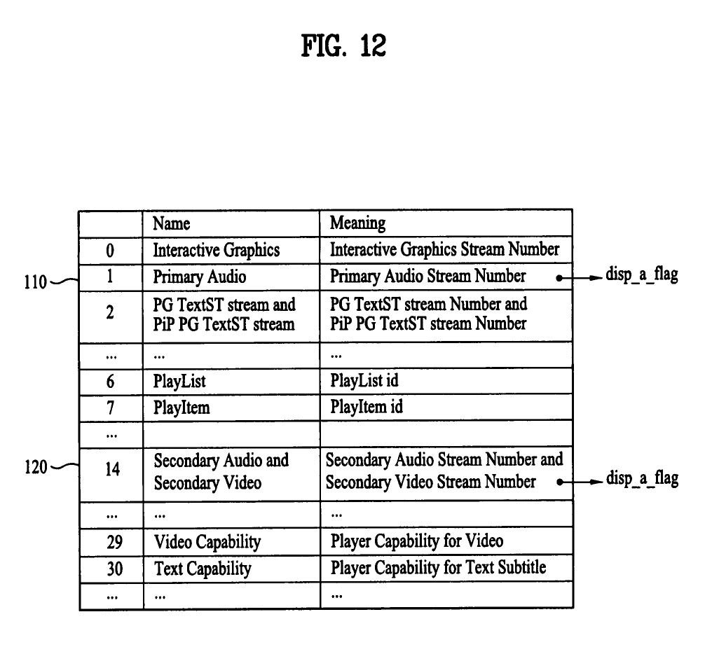

FIG. 12 illustrates an exemplary embodiment of the status memory units equipped in the optical recording/reproducing apparatus according to the present invention.

The player registers 176b included in the optical recording/reproducing apparatus 10 function as memory units in which information as to the recording/playback status and recording/playback environment of the player are stored. The player registers 176b may be classified into general purpose registers (GPRs) and player status registers (PSRs). Each PSR stores a playback status parameter (for example, an ‘interactive graphics stream number’ or a ‘primary audio stream number’), or a configuration parameter of the optical recording/reproducing apparatus (for example, a ‘player capability for video’). Since a secondary video is reproduced, in addition to a primary video, PSRs for the reproduction status of the secondary video are provided. Also, PSRs for the reproduction status of the secondary audio associated with the secondary video are provided.

The stream number of the secondary video may be stored in one of the PSRs (for example, a PSR14 120). In the same PSR (namely, PSR14), the stream number of a secondary audio associated with the secondary video may also be stored. The ‘secondary video stream number’ stored in the PSR14 120 is used to specify which secondary video stream should be presented from secondary video stream entries in the STN table of the current playitem. Similarly, the ‘secondary audio stream number’ stored in the PSR14 120 is used to specify which secondary audio stream should be presented from secondary audio stream entries in the STN table of the current playitem. The secondary audio is defined by the secondary video/secondary audio combination information of the secondary video.

As shown in FIG. 12, the PSR14 120 may store a flag ‘disp_a_flag’. The flag ‘disp_a_flag’ indicates whether output of the secondary audio is enabled or disabled. For example, when the flag ‘disp_a_flag’ is set to a value corresponding to an enabled state, the secondary audio is decoded, and presented to the user after being subjected to a mixing process in the associated audio mixer such that the decoded secondary audio is mixed with the primary audio and/or interactive audio. On the other hand, if the flag ‘disp_a_flag’ is set to a value corresponding to a disabled state, the secondary audio is not output even when the secondary audio is decoded by the associated decoder. The flag ‘disp_a_flag’ may be varied by the user operation (UO), user command, or application programming interface (API).

The stream number of the primary audio may also be stored in one of the PSRs (for example, a PSR1 110). The ‘primary audio stream number’ stored in the PSR1 110 is used to specify which primary audio stream should be presented from primary audio stream entries in the STN table of the current playitem. When the value stored in the PSR1 110 is varied, the primary audio stream number is immediately changed to a value identical to the value stored in the PSR1 110.

The PSR1 110 may store a flag ‘disp_a_flag’. The flag ‘disp_a_flag’ indicates whether output of the primary audio is enabled or disabled. For example, when the flag ‘disp_a_flag’ is set to a value corresponding to an enabled state, the primary audio is decoded, and presented to the user after being subjected to a mixing process in the associated audio mixer such that the decoded primary audio is mixed with the secondary audio and/or interactive audio. On the other hand, if the flag ‘disp_a_flag’ is set to a value corresponding to a disabled state, the primary audio is not output even when the primary audio is decoded by the associated decoder. The flag ‘disp_a_flag’ may be changed by user operation (UO), user command, or API.

FIGS. 13A to 13C illustrate sub path types according to the present invention.

As described above with reference to FIGS. 10A and 10B, in accordance with the present invention, the sub path used to reproduce the secondary video and secondary audio is varied depending on the method for encoding the secondary video and secondary audio. Accordingly, the sub path types according to the present invention may be mainly classified into three types in accordance with whether or not the sub path is synchronous with the main path. Hereinafter, the sub path types according to the present invention will be described with reference to FIGS. 13A to 13C.

FIG. 13A illustrates the case in which the encoding type of data is the ‘out-of-mux’ type, and the sub path is synchronous with the main path.

Referring to FIG. 13A, the playlist for managing the primary and secondary videos, and the primary and secondary audios includes one main path and one sub path. The main path is configured by four playitems (‘PlayItem_id’=0, 1, 2, 3), whereas the sub path is configured by a plurality of subplayitems. The secondary video and secondary audio, which are reproduced through the sub paths, are synchronous with the main path. In detail, the sub path is synchronized with the main path, using information ‘sync-PlayItem_id’, which identifies a playitem associated with each subplayitem, and presentation time stamp information ‘sync_start_PTS_of_PlayItem’, which indicates a presentation time of the subplayitem in the playitem. That is, when the presentation point of the playitem reaches a value referred to by the presentation time stamp information, the presentation of the associated subplayitem is begun. Thus, reproduction of the secondary video through one sub path is begun at a set time during the reproduction of the primary video through the main path.

In this case, the playitem and subplayitem refer to different clips, respectively. The clip referred to by the playitem is provided to the AV decoder 17b as a main stream, whereas the clip referred to by the subplayitem is provided to the AV decoder 17b as a sub stream. The primary video and primary audio included in the main stream are decoded by the primary video decoder 730a and primary audio decoder 730e, respectively, after passing through the depacketizer 710a and PID filter-1 720a. On the other hand, the secondary video and secondary audio included in the sub stream are decoded by the secondary video decoder 730b and secondary audio decoder 730f, respectively, after passing through the depacketizer 710b and PID filter-2 720b.

FIG. 13B illustrates the case in which the encoding type of data is the ‘out-of-mux’ type, and the sub path is asynchronous with the main path. Similar to the sub path type of FIG. 13A, in the sub path type of FIG. 13A, secondary video streams and/or secondary audio streams, which will be reproduced through sub paths, are multiplexed in a state of being separated from a clip to be reproduced based on the associated playitem. However, the sub path type of FIG. 13B is different from the sub path type of FIG. 13A in that the presentation of the sub path can be begun at any time on the timeline of the main path.

Referring to FIG. 13B, the playlist for managing the primary and secondary videos and the primary and secondary audios includes one main path and one sub path. The main path is configured by three playitems (‘PlayItem_id’=0, 1, 2), whereas the sub path is configured by one subplayitem. The secondary video and secondary audio, which are reproduced through the sub path, are asynchronous with the main path. That is, even when the subplayitem includes information for identifying a playitem associated with the subplayitem, and presentation time stamp information indicating a presentation time of the subplayitem in the playitem, this information is not valid in the sub path type of FIG. 13B. Accordingly, the user can view the secondary video at any time during the presentation of the main path.

In this case, since the encoding type of the secondary video is the ‘out-of-mux’ type, the primary video and primary audio are provided to the AV decoder 17b as a main stream, and the secondary video and secondary audio are provided to the AV decoder 17b as a sub stream, as described above with reference to FIG. 13A.

FIG. 13C illustrates the case in which the encoding type of data is the ‘in-mux’ type, and the sub path is synchronous with the main path. The sub path type of FIG. 13C is different from those of FIGS. 13A and 13B in that the secondary video and secondary audio are multiplexed in the same AV stream as the primary video.

Referring to FIG. 13C, the playlist for managing the primary and secondary videos and the primary and secondary audios includes one main path and one sub path. The main path is configured by four playitems (‘PlayItem_id’=0, 1, 2, 3), whereas the sub path is configured by a plurality of subplayitems. Each of the subplayitems constituting the sub path includes information for identifying a playitem associated with the subplayitem, and presentation time stamp information indicating a presentation time of the subplayitem in the playitem. As described above with reference to FIG. 13A, each subplayitem is synchronized with the associated playitem, using the above-described information. Thus, the sub path is synchronized with the main path.

In the sub path type of FIG. 13C, each of the playitems constituting the main path and an associated one or ones of the subplayitems constituting the sub path refer to the same clip. That is, the sub path is presented using a stream included in the clip managed by the main path. Since the clip is managed by the main path, the clip is provided to the AV decoder 17b as a main stream. The main stream, which is packetized data including primary and secondary videos and primary and secondary audios, is sent to the depacketizer 710a which, in turn, depacketizes the packetized data. The depacketized primary and secondary videos and depacketized primary and secondary audios are provided to the primary and secondary video decoders 730a and 730b and primary and secondary audio decoders 730e and 730f in accordance with associated packet identifying information, and are then decoded by the primary and secondary video decoders 730a and 730b and the primary and secondary audio decoders 730e and 730f, respectively.

The main stream and sub stream may be provided from the recording medium 30 or storage 15 to the AV decoder 17b. Where the primary and secondary videos are stored in different clips, respectively, the primary video may be recorded in the recording medium 30, to be provided to the user, and the secondary video may be downloaded from the outside of the recording medium 30 to the storage 15. Of course, the case opposite to the above-described case may be possible. However, where both the primary and secondary videos are stored in the recording medium 30, one of the primary and secondary videos may be copied to the storage 15, prior to the reproduction thereof, in order to enable the primary and secondary videos to be simultaneously reproduced. In case that both the primary and secondary videos are stored in the same clip, they are provided after being recorded in the recording medium 30. In this case, however, it is possible that both the primary and secondary videos are downloaded from outside of the recording medium 30.

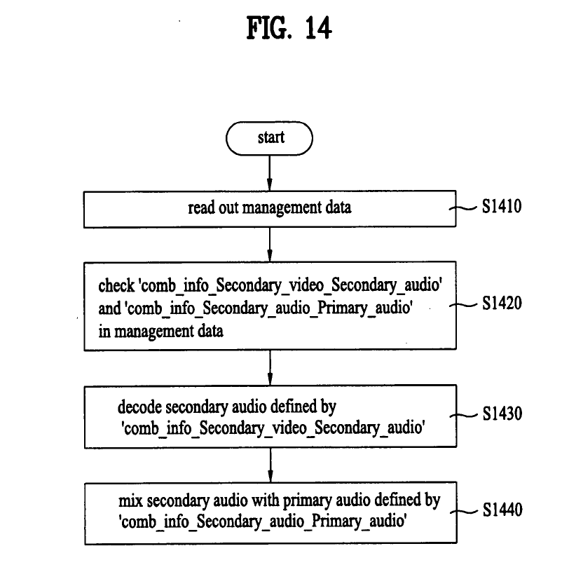

FIG. 14 is a flow chart illustrating a method for reproducing data in accordance with the present invention.

When reproduction of data is begun, the controller 12 reads out data from the recording medium 30 or storage 15 (S1410). The data not only includes primary video, primary audio, secondary video, and secondary audio data, but also includes management data for managing the reproduction of the data. The management data may include a playlist, playitems, STN tables, clip information, etc.

In accordance with the present invention, the controller 12 checks a secondary audio allowed to be reproduced along with the secondary video, from the management data (S1420). The controller 12 also identifies a primary audio allowed to be mixed with the secondary audio, from the management data (S1420). Referring to FIG. 5, information ‘comb_info_Secondary_video_Secondary_audio’ 520 defining secondary audio allowed to be reproduced along with the secondary video, the stream entries of which are stored in the associated STN table, may be stored in the STN table. Also, information ‘comb_info_Secondary_audio_Primary_audio’ 510 defining primary audio allowed to be mixed with the secondary audio may be stored in the STN table. One of the secondary audio streams defined by the information ‘comb_info_Secondary_video_Secondary_audio’ 520 is decoded in the secondary audio decoder 740f (S1430), and is then provided to the primary audio mixer 750a.

The stream number of the decoded secondary audio is stored in the PSR14 120. In accordance with an embodiment of the present invention, the PSR14 120 may store a flag ‘disp_a_flag’. Under the condition in which the flag ‘disp_a_flag’ has been set to a value corresponding to a disabled state, the secondary audio is prevented from being output (OFF). As described above with reference to FIG. 12, the flag ‘disp_a_flag’ is variable by the user operation (UO), user command, or API. That is, the output of the secondary audio can be turned ON and OFF by the user operation (UO), user command, or API.

The secondary audio decoded in the secondary audio decoder 730f is mixed with the primary audio defined by the information ‘comb_info_Secondary_audio_Primary_audio’ 510 in the primary audio mixer 750a (S1440). The primary audio to be mixed is provided to the primary audio mixer 750a after being decoded in the primary audio decoder 730e.

The stream number of the decoded primary audio is stored in the PSR1 110. In accordance with an embodiment of the present invention, the PSR1 110 may store a flag ‘disp_a_flag’. Under the condition in which the flag ‘disp_a_flag’ has been set to a value corresponding to a disabled state, the primary audio is prevented from being output (OFF). As described above with reference to FIG. 12, the flag ‘disp_a_flag’ is changeable by the user operation (UO), user command, or API. That is, the output of the primary audio can be turned ON and OFF by the user operation (UO), user command, or API.

In accordance with the present invention, it is possible to reproduce the secondary video along with the secondary audio. Also, the content provider can control mixing of audios, or can control output of an audio between ON and OFF statuses, using a command set.

As apparent from the above description, in accordance with the data reproducing method and apparatus, recording medium, and data recording method and apparatus of the present invention, it is possible to simultaneously reproduce primary and secondary videos. In addition, the user or content provider can control mixing of audios, or can control output of an audio. Accordingly, there are advantages in that the content provider can compose more diverse contents, to enable the user to experience more diverse contents. Also, there is an advantage in that the content provider can control audios to be provided to the user.

It will be apparent to those skilled in the art that various modifications and variations can be made in the present invention without departing from the spirit or scope of the inventions. Thus, it is intended that the present invention covers the modifications and variations of this invention.

What is claimed is:

1. A method of managing reproduction of at least one audio stream downloaded from an external source for at least one picture-in-picture presentation path, comprising:
reproducing management information for managing reproduction of at least one secondary video stream and at least one secondary audio stream, the secondary video stream representing the picture-in-picture presentation path with respect to a primary presentation path represented by a primary video stream, and the management information including sub-path type information, the sub-path type information indicating the sub path type of the secondary audio stream; and
reproducing at least one of the secondary audio streams based on the first combination information.

2. The method of claim 1, the sub-path type of the secondary audio stream is one of out-of-mux and in-mux.

3. The method of claim 2, the sub-path type of the secondary audio stream is out-of-mux.

4. The method of claim 1, the management information further includes whether or not the sub-path of the secondary audio stream is synchronous with respect to the primary presentation path.

5. The method of claim 4, the secondary audio stream is synchronous with respect to the primary presentation path.

6. The method of claim 1, the management information further includes a first combination information, the first combination information indicating that are combinable with the secondary video stream.

7. The method of claim 6, the first combination information is down-loadable outside the recording medium.

8. The method of claim 6, the first combination information is downloadable outside the recording medium, along with the at least one secondary audio stream.

9. The method of claim 6, wherein the reproducing at least one of the secondary audio streams step comprises:
checking the first combination information; and
decoding one of the secondary audio streams indicated as combinable with the secondary video stream based on the checking step.

10. The method of claim 6, wherein the first combination information includes an information field indicating a number of secondary audio stream entries associated with the secondary video stream, and the combination information provides a secondary audio stream identifier for each of the number of the secondary audio stream entries.

11. The method of claim 1, wherein the management information indicates a number of secondary video stream entries and for each of the number of secondary video stream entries, the management information provides a secondary video stream identifier and the first combination information.

12. The method of claim 1, wherein the management information includes second combination information, the second combination information indicating the primary audio streams that are combinable with the secondary audio stream.

13. The method of claim 1, wherein the second combination information is downloadable outside the recording medium.

14. A method of managing reproduction of at least one audio stream for at least one picture-in-picture presentation path, comprising:
receiving at least one secondary audio stream from an external source;
selecting which one of secondary audio stream from an external source and audio stream from recording medium to be reproduced;
reproducing management information for managing reproduction of at least one secondary video stream and at least one secondary audio stream, the secondary video stream representing the picture-in-picture presentation path with respect to a primary presentation path represented by a primary video stream, and the management information including sub-path type information, the sub-path type information indicating the sub path type of the secondary audio stream; and
reproducing at least one of the secondary audio streams based on the first combination information.

15. An apparatus for managing reproduction of at least one audio stream downloaded outside a recording medium for at least one picture-in-picture presentation path, comprising:
a driver configured to drive a reproducing device to reproduce data from the recording medium and data downloaded outside the recording medium; and
a controller configured to control the driver to reproduce management information for managing reproduction of at least one secondary video stream and at least one secondary audio stream, the secondary video stream representing the picture-in-picture presentation path with respect to a primary presentation path represented by a primary video stream, and the management information including sub-path type information, the sub-path type information indicating the sub path type of the secondary audio stream; and
the controller configured to reproduce at least one of the secondary audio streams based on the first combination information.

16. The apparatus of claim 15, the sub-path type of the secondary audio stream is one of out-of-mux and in-mux.

17. The apparatus of claim 16, the sub-path type of the secondary audio stream is out-of-mux.

18. The apparatus of claim 15, the management information further includes whether or not the sub-path of the secondary audio stream is synchronous with respect to the primary presentation path.

19. The apparatus of claim 18, the secondary audio stream is synchronous with respect to the primary presentation path.

20. The apparatus of claim 15, the management information further includes a first combination information, the first combination information indicating that are combinable with the secondary video stream.

21. The apparatus of claim 15, the management information further includes a second combination information, the second combination information indicating the primary audio streams that are combinable with the secondary audio stream.

22. An apparatus for managing reproduction of at least one audio stream for at least one picture-in-picture presentation path, comprising:
a storage configured to store at least one secondary audio stream downloaded from an external source;
a selector configured to select one of secondary audio stream downloaded from an external source or secondary audio stream from a recording medium
a driver configured to drive a reproducing device to reproduce data from the recording medium and data downloaded outside the recording medium; and
a controller configured to control the driver to reproduce management information for managing reproduction of at least one secondary video stream and at least one secondary audio stream, the secondary video stream representing the picture-in-picture presentation path with respect to a primary presentation path represented by a primary video stream, and the management information including sub-path type information, the sub-path type information indicating the sub path type of the secondary audio stream; and
the controller configured to reproduce at least one of the secondary audio streams based on the first combination information.
